(19) United States
(12) Patent Application Publication
(10) Pub. No.: US 2015/0042098 A1
(43) Pub. Date: Feb. 12, 2015

(54) HAWT Having Low-position Nacelle Upwardly Linked to a Rotor through a Crank System

(71) Applicant: Kuo-Shen Liu, Taipei (TW)

(72) Inventor: Kuo-Shen Liu, Taipei (TW)

(21) Appl. No.: 13/959,752

(22) Filed: Aug. 6, 2013

(51) Int. Cl. F03D 3/00; F03D 9/00

(52) U.S. Cl. CPC F03D 3/002; F03D 9/002
USPC 290/55

(57) ABSTRACT

A horizontal axis wind turbine (HAWT) includes: a tower, a rotor rotatably mounted on an upper portion of the tower, an upper crank unit mounted in an upper portion of the tower and operatively rotated by the rotor, a lower crank unit mounted in a lower portion of the tower and linked to the upper crank unit to be driven and rotated by the upper crank unit, a kinetic-force conversion apparatus connected to and rotatably driven by the lower crank unit to convert the kinetic energy to an output electricity, and a nacelle secured to a lower portion of the tower for mounting the kinetic-force conversion apparatus in the nacelle, with the nacelle approximating to the tower bottom for enhancing stability and safety of the HAWT, and also for reducing the installation, operation and maintenance cost of the HAWT.

### BACKGROUND OF THE INVENTION

A conventional jumbo horizontal axis wind turbine (HAWT) as shown in FIG. 1 comprises: a nacelle N having a kinetic energy transmission and conversion apparatus K mounted in the nacelle N for converting the kinetic energy to electricity which is output at electric power terminals E, a rotor R having blades radially secured to a hub H and a shaft S and operatively driving the kinetic energy transmission and conversion apparatus K, a bearing B disposed around the shaft S for rotatably mounting the shaft S in the nacelle N, a yawing device Y for orienting the nacelle and rotor to face the wind direction, and a tower T fixed on a foundation F for mounting the nacelle N on the top portion of tower.

Since a nacelle for such a conventional jumbo HAWT for producing one million (or above) watts may have a heavy weight of more than 100 tons, and the nacelle may have a height of 100 meters as indicated by H1, such a HAWT may have the following drawbacks:
1. A great moment caused by the heavy nacelle and high tower of such a jumbo HAWT may increase the difficulty of installation, operation and maintenance of the HAWT.
2. Such a HAWT with heavy nacelle mounted on the high tower, when subjected to a strong wind such as tornado or typhoon, was very dangerous as seriously damaged or broken, as ever happened in China, Japan and Taiwan.
3. The building cost especially for tower and foundation may be greatly increased in order to safely install, operate and maintain such a HAWT which requires high strength, high stability and high safety factors.

Such defects of the conventional jumbo HAWT may hinder the development of wind energy.

U.S. Pat. No. 7,192,252 to Duguet et al. disclosed a safety device for a wind turbine which includes a mast having at least two segments articulated to one another so as to pivot between a straightened position and a folded position. Such a wind turbine can be folded down under high wind for safety.

However, such a prior art (U.S. Pat. No. 7,192,252) may still have the drawbacks of high production cost and engineering complexity for building, erecting, folding and maintaining such an articulated mast of the wind turbine.

Recently, as lacking of building land or opposed by the residents, there is a tendency to build the wind turbine offshore or on the sea. A Floating Wind Turbine (FWT) is thus developed for those areas having water depth of more then 50 meters. However, the conventional FWT has its nacelle positioned as high as 100 meters, resulting in a unstable gravity center of the floating base, causing unstable operation of FWT, and thereby affecting the commercializing development of FWT.

The present inventor has found the drawbacks of the conventional HAWTs and invented the present HAWT as stably and economically constructed both on land and offshore, and both for fixed foundation and FWT.

### SUMMARY OF THE INVENTION

The object of the present invention is to provide a horizontal axis wind turbine (HAWT) including: a tower, a rotor rotatably mounted on an upper portion of the tower, an upper crank unit mounted in an upper portion of the tower and operationally rotated by the rotor, a lower crank unit mounted in a lower portion of the tower and linked to the upper crank unit to be driven and rotated by the upper crank unit, a kinetic-force conversion apparatus connected to and rotatably driven by the lower crank unit to convert the kinetic energy to an output electricity, and a nacelle secured to a lower portion of the tower for mounting the kinetic-force conversion apparatus in the nacelle, with the nacelle positioned to approximate to the tower bottom for enhancing stability and safety of the HAWT, and also for reducing the installation, operation and maintenance cost of the HAWT.

### BRIEF DESCRIPTION OF THE DRAWINGS

FIG. 1 is an illustration of a prior art of HAWT.

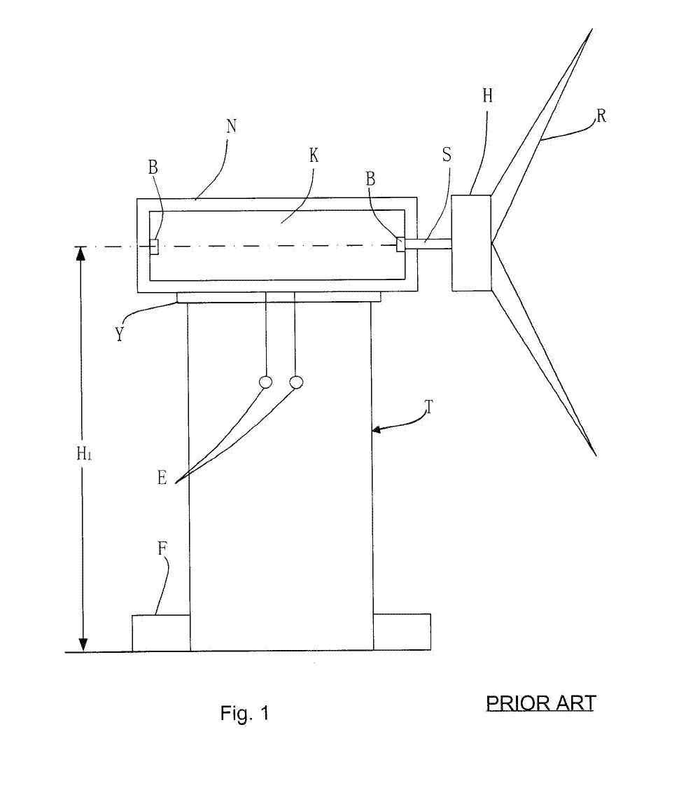

FIG. 2 is an illustration of the HAWT of the present invention.

FIG. 3 shows a modified tower of the present invention.

FIG. 4 shows another preferred embodiment of the present invention.

### DETAILED DESCRIPTION

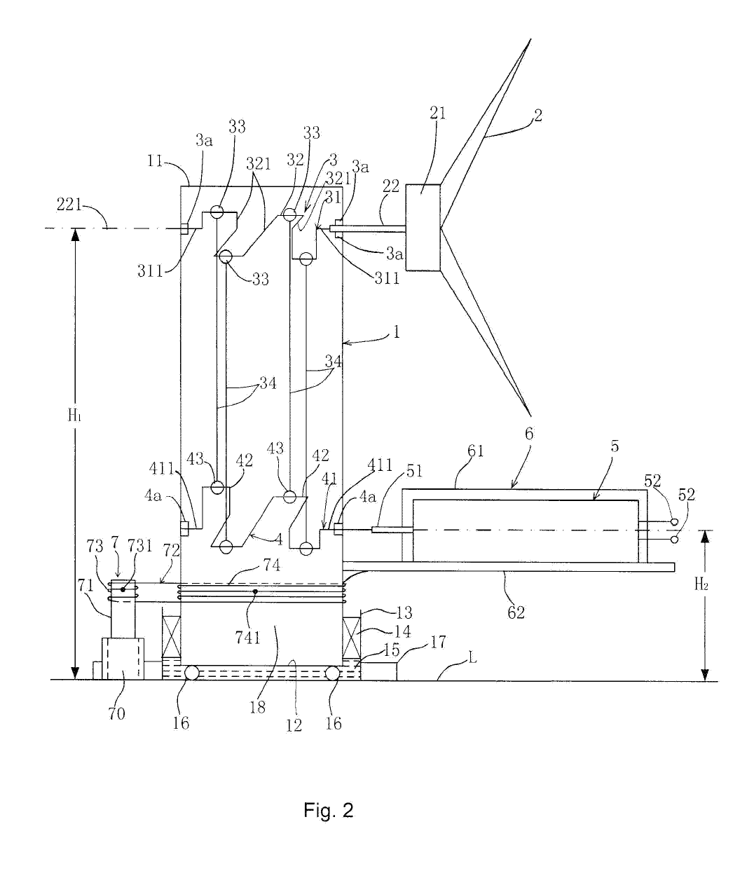

As shown in FIG. 2, the horizontal axis wind turbine (HAWT) of the present invention comprises: a tower 1, a rotor 2 rotatably mounted on an upper or top portion of the tower 1, an upper crank unit 3 mounted in an upper portion of the tower 1 and operatively rotated by the rotor 2 when facing to wind direction, a lower crank unit 4 mounted in a lower portion of the tower 1 and linked to the upper crank unit 3 to be driven and rotated by the upper crank unit 3, a kinetic-force conversion apparatus 5 connected to and rotatably driven by the lower crank unit 4 to convert the kinetic energy to an electricity to output, and a nacelle 6 secured to a lower portion of the tower 1 approximating to the bottom 12 of the tower 1 for mounting the kinetic-force conversion apparatus 5 in the nacelle 5.

The upper crank unit 3 and the lower crank unit 4 may be combinably defined as a crank system (3, 4).

The HAWT of the present invention further comprises a yawing device 7 which will swivel the tower 1 automatically for orienting the tower 1 and the rotor 2 to face the wind direction.

The tower 1, the rotor 2 and the nacelle 6 having the kinetic-force conversion apparatus 5 mounted therein may be suitably positioned in order to obtain a well-balanced structure of the whole system of HAWT. For instance, the nacelle 6 may be secured to the lower portion of the tower 1 opposite to the rotor 2 secured to the upper portion of the tower 1 for static and dynamic balancing of the whole system HAWT to minimize the vibration or instability of the HAWT.

The nacelle 6 may also be mounted within the tower 1 if space or internal volume of the tower is allowable.

The tower 1 designates a rotor shaft height H1 defined between an axis of the rotor shaft 22 and a ground or sea level L where the tower 1 is erected.

The nacelle 6 designates the height H2 of the main shaft 51 which is the axis of the kinetic-force conversion apparatus 5 (installed in the nacelle 6) near the ground (or sea) level L; and includes a nacelle bottom platform 62 secured to the lower portion of tower 1.

For stabilization of the HAWT of the present invention, the heights H1 and H2 may satisfy the following formulas:

H2=f×H1.

wherein “f” is a factor of 0.01˜0.5.

Nevertheless, the heights H1 and H2 are not limited in the present invention. It is preferable to mount the nacelle 6 as low as possible to approximate to the bottom 12 of tower 1 in order to enhance the safety and stability of the HAWT.

The rotor 2 includes a plurality of blades radially secured to a hub 21 which is axially secured to a rotor shaft 22 coupled or connected to the upper crank unit 3, and mounted on the upper portion of tower 1.

The upper crank unit 3 includes: an upper crankshaft 31 having two upper shaft portions 311 respectively connected to the rotor shaft 22 and the tower 1 by a set of upper bearings 3a; a plurality of upper crankpins 32 connected in between the two upper shaft portions 311 of the upper crankshaft 31, with each upper crankpin 32 having a pair of webs 321 disposed on opposite ends of the upper crankpin 32, and each web 321 of one crankpin 32 is connected to another web 321 of a neighboring crankpin 32 to be deviated each other in a phase angle of 90 degrees or 180 degrees (not limited); each upper crankpin 32 having an upper ring bearings 33 rotatably wrapped around each upper crankpin 32; and a plurality of connecting members 34 each respectively connected to each upper ring bearings 33 of each upper crankpin 32, and downwardly connected to the lower crank unit 4, whereby upon a rotary driving by the rotor 2, a rotary motion of the upper crank unit 3 will be converted to a linear reciprocative motion of each connecting member 34, which, in turn, will be converted to a rotary motion of the lower crank unit 4, thereby rotating the lower crank unit 4 accordingly.

The lower crank unit 4 includes: a lower crankshaft 41 having two lower shaft portions 411 respectively connected to a main shaft 51 of the kinetic-force conversion apparatus 5 and connected to the tower 1 by a set of lower bearings 4a; a plurality of lower crankpins 42 connected in between the two lower shaft portions 411 of the lower crankshaft 41; each lower crankpin 42 having a lower ring bearings 43 rotatably wrapped around each lower crankpin 42; each lower ring bearings 43 connected to each connecting member 34 which is upwardly connected to each upper ring bearings 33 of the upper crank unit 3; and the lower crankshaft 41 connected to a main shaft 51 of the kinetic-force conversion apparatus 5.

The yawing device 7 as shown in FIG. 2 which may be a capstan including: a driving barrel 71, a driving motor 70 axially connected with the driving barrel 71 for rotating the driving barrel 71 clockwise or counter-clockwise, a cable (or rope) 72 continuously or endlessly wrapped around the driving barrel 71 and a follower cylinder portion 18 formed on a lower portion of the tower 1; in which a set of driving windings 73 of the cable 72 is wound on the driving barrel 71 with a middle portion 731 of the driving windings 73 fixed to the driving barrel 71, while a set of follower windings 74 of the cable 72 is wound on the follower cylinder portion 12a with a middle portion 741 of the follower windings 74 fixed to the follower cylinder portion 18.

When subjected to a wind as detected by a wind direction sensor or detector, the yawing device (capstan) 7 will be started to rotate the driving barrel 71 to cooperatively rotate the follower cylinder portion 18 of the tower 1 clockwise or counter-clockwise in order to rotate the tower 1 and the rotor 2 to face the wind direction.

The cylinder portion 18 on the lower portion of tower 1 is rotatably held in a bearings 14 disposed in an outer cylindrical wall 13 of a foundation 17, having a hydraulic oil 15 filled into the cylindrical wall 13 for smoothening the rotation of tower 1 and for dampening the vibrational shock. The bottom 12 is also rotatably supported by a plurality of bottom casters or universal bearings 16.

The blades of the rotor 2, when rotated as driven by wind, will rotate the rotor shaft 22 and the crankshaft 31 of the upper crank unit 3 at the upper portion of the tower. The rotation of crankshaft 31 will rotate each crankpin 32 to reciprocatively push or pull the connecting member 34 in order to cooperatively rotate each lower crankpin 42 at the lower portion of the tower to rotate the lower crankshaft 41 and the main shaft 51 of the kinetic-force conversion apparatus (or a power generator) 5 to output electricity through the terminals 52.

Since the heavy nacelle 6 with the kinetic-force conversion apparatus 5 mounted in the nacelle 6 is installed at the lower portion of tower 1, the present invention may have the following advantages to be superior to the conventional HAWTs:
1. The nacelle and the kinetic-force conversion apparatus are installed at the lower portion of the tower to help stabilize the tower construction to enhance the safety of HAWT.
2. The installation operation and maintenance cost can be minimized or reduced since the heavy nacelle has been lowered, and the engineering standard for building those conventional HAWTs with high-positioned nacelles may then be lowered.
3. The heavy elements (the nacelle and the kinetic-force conversion apparatus) have been lowered in position so that the assembly, erection and building of the HAWT will become easy, and the supervision therefor may also be easy.

The present invention may be further modified without departing from the spirit and scope of the present invention.

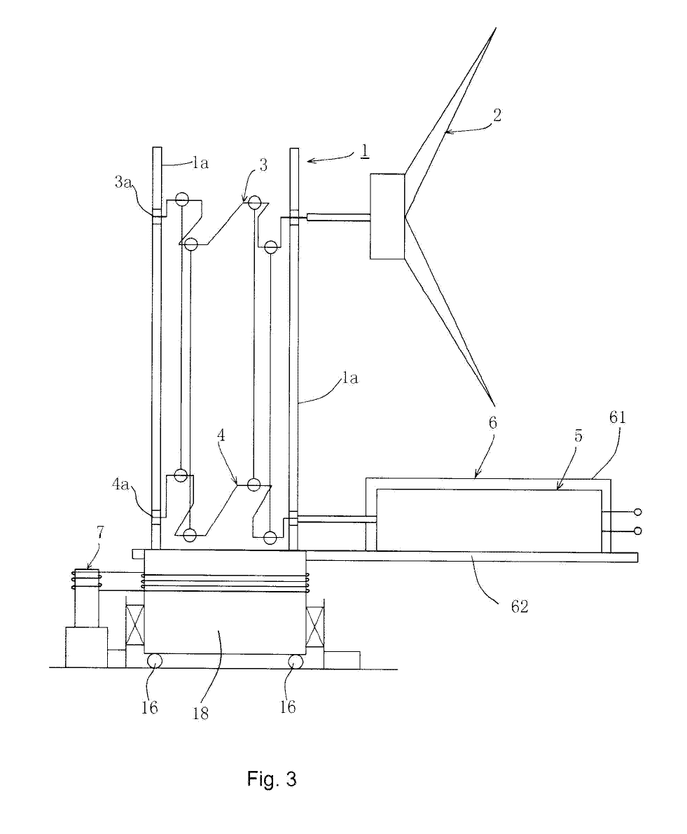

As shown in FIG. 3, the upper tower is simply modified to be a pair of steel columns or plates 1a, 1a juxtapositionally erected on the lower cylinder portion 18 of the tower 1 for rotatably mounting the upper and lower crank units 3, 4 in between the two steel columns 1a, 1a for reducing the cost of HAWT.

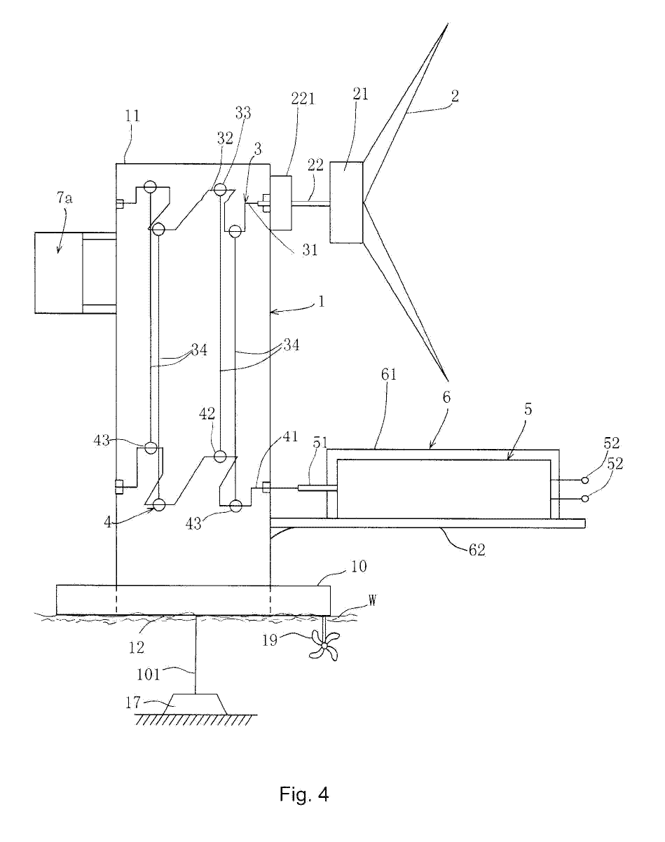

The number of crankshafts 31, 41 are not limited in the present invention. For dampening the vibration shock, the tower 1 may be rotatably suspended in a hydraulic oil (system) 15 as shown in FIG. 2, or the tower may be loaded on a float 10 floating on sea water W as shown in FIG. 4. A planetary gear system 221 my be coupled between the rotor shaft 22 and the upper crank shaft 31 for increasing the output rotation speed or force of the crank unit 3.

In FIG. 4, the yawing device 7 has been modified to be a tail fin 7a secured to the tower 1 for orienting the tower and rotor blade to face the wind direction. A mooring rope 101 is provided to connect the float 10 and the foundation 17 which is fixed into the sea bed. Still, a marine propeller 19 may be mounted in a peripheral bottom portion of the float 10 for rotating the tower 1 about a tower axis to untwist the mooring rope 101 once twisted.

Other modifications may still be made in accordance with the present invention. The output ratings of the present invention are not limited in this invention.

The pair of steel columns 1a, 1a as shown in FIG. 3 may be modified to be juxtapositionally formed on a floating platform as floating on a sea.

I claim:

1. A horizontal axis wind turbine (HAWT) comprising: a tower, a rotor rotatably mounted on an upper or top portion of the tower, an upper crank unit mounted in an upper portion of the tower and operatively rotated by the rotor when facing to and rotated by wind, a lower crank unit mounted in a lower portion of the tower and linked to the upper crank unit to be driven and rotated by the upper crank unit, a kinetic-force conversion apparatus connected to and rotatably driven by the lower crank unit to produce and convert a kinetic energy to electricity output, and a nacelle secured to a lower or bottom portion of the tower for mounting the kinetic-force conversion apparatus in the nacelle.

2. A HAWT according to claim 1, wherein said HAWT further comprises a yawing device secured or coupled to the tower for orienting the tower and the rotor to face the wind direction in order to allow the rotor to be rotatably driven by wind.

3. A horizontal axis wind turbine according to claim 1, wherein said tower designates a rotor shaft height H1 defined between an axis of the rotor shaft and a ground or sea level where the tower is erected; and said nacelle designates a main shaft height H2 defined between an axis of the main shaft of the kinetic-force conversion apparatus mounted in the nacelle and the ground (or sea) level; wherein the heights H1 and H2 respectively satisfy the following formula:
H2=f×H1.
wherein “f” is a factor of 0.01˜0.5.

4. A horizontal axis wind turbine according to claim 1, wherein said upper crank unit includes: an upper crankshaft having two upper shaft portions respectively connected to the rotor shaft and the tower; a plurality of upper crankpins connected in between the two upper shaft portions of the upper crankshaft, with each said upper crankpin having a pair of webs disposed on opposite ends of the upper crankpin, and one said web of one said upper crankpin is connected to another web of a neighboring upper crankpin to be deviated each other in a phase angle; each said upper crankpin having an upper ring bearings rotatably wrapped around each said upper crankpin; and a plurality of connecting members each respectively connected to each said upper ring bearings of each said upper crankpin, and downwardly connected to the lower crank unit, whereby upon a rotary driving by said rotor, a rotary motion of said upper crank unit is converted to a linear reciprocative motion of each said connecting member to thereby rotate said lower crank unit.

5. A horizontal axis wind turbine according to claim 4, wherein said lower crank unit includes: a lower crankshaft having two lower shaft portions respectively connected to the kinetic-force conversion apparatus and the tower; a plurality of lower crankpins connected in between the two lower shaft portions of the lower crankshaft; each said lower crankpin having a lower ring bearings rotatably wrapped around each said lower crankpin; each said lower ring bearings connected to each said connecting member which is upwardly connected to each said upper ring bearings of the upper crank unit; and the lower crankshaft connected to a main shaft of the kinetic-force conversion apparatus.

6. A horizontal axis wind turbine according to claim 2, wherein said yawing device comprises a capstan including: a driving barrel, a driving motor axially connected with the driving barrel for rotating the driving barrel clockwise or counter-clockwise by a detector of wind direction, a cable continuously or endlessly wrapped around the driving barrel and a follower cylinder portion formed on a lower portion of the tower; in which a set of driving windings of the cable is wound on the driving barrel with a middle portion of the driving windings fixed to the driving barrel, and a set of follower windings of the cable wound on the follower cylinder portion with a middle portion of the follower windings fixed to the follower cylinder portion, whereby when subjected to a wind as sensed by the detector, the capstan is started to rotate the driving barrel to cooperatively rotate the follower cylinder portion of the tower clockwise or counter-clockwise in order to rotate the tower and the rotor to face the wind direction.

7. A horizontal axis wind turbine according to claim 6, wherein a bottom of the tower is rotatably held in a bearings disposed in an outer cylindrical wall, having a hydraulic oil filled into the cylindrical wall for smoothening the rotation of tower and for dampening the vibrational shock.

8. A horizontal axis wind turbine according to claim 1, wherein said tower is loaded on a float floating on sea water, having a mooring rope provided to connect the float and a foundation which is fixed into a sea bed.

9. A horizontal axis wind turbine according to claim 8, wherein said float further includes a marine propeller mounted in a peripheral bottom portion of the float for rotating the tower to untwist the mooring rope once twisted.

10. A horizontal axis wind turbine according to claim 1, wherein said tower includes a plurality of bottom bearings or universal casters mounted on a tower bottom for smoothening the rotation of the tower.

11. A horizontal axis wind turbine according to claim 2, wherein said yawing device includes a tail fin secured to the tower for orienting the tower and rotor to face the wind direction.

12. A horizontal axis wind turbine according to claim 1, wherein said HAWT further includes a planetary gear system coupled between a rotor shaft of said rotor and a crankshaft of said upper crank unit for increasing an output rotation speed or force of the upper crank unit.

13. A HAWT according to claim 1, wherein said tower includes a pair of steel columns or plates juxtapositioned with each other for rotatably mounting said upper and lower crank units between said pair of steel columns or plates.
